(19) United States
(12) Patent Application Publication
(10) Pub. No.: US 2024/0097421 A1
(43) Pub. Date: Mar. 21, 2024

(54) BUS BAR UNIT FIXING METHOD

(71) Applicant: HONDA MOTOR CO., LTD., Tokyo (JP)

(72) Inventors: Masaki TAKAHASHI, Tokyo (JP); Takahiro UNEME, Tokyo (JP)

(73) Assignee: HONDA MOTOR CO., LTD., Tokyo (JP)

(21) Appl. No.: 18/370,194

(22) Filed: Sep. 19, 2023

(30) Foreign Application Priority Data
Sep. 21, 2022 (JP) 2022-150437

(51) Int. Cl. H02G 5/06

(52) U.S. Cl. CPC H02G 5/06

(57) ABSTRACT

A bus bar unit includes a bus bar including two ends and tending from a first end to a second end, and a connector unit molded to be integrated with the bus bar. A first bolt insertion hole is formed in the first end. A second bolt insertion hole is formed in the connector unit. The bus bar unit is fixed, by fixing the bus bar unit to a fixing-object member, connecting the first end to a connection terminal provided on an electronic component, and connecting a cable to the second end. A bus bar unit fixing method includes a step of inserting the first bolt through the first bolt insertion hole and fastening the first end of the bus bar to the connection terminal, and a step of inserting the second bolt through the second bolt insertion hole and fixing the connector unit to the fixing-object member.

### CROSS-REFERENCE TO RELATED APPLICATIONS

This application is based on and claims priority under 35 USC 119 from Japanese Patent Application No. 2022-150437 filed on Sep. 21, 2022, the contents of which are incorporated herein by reference.

### TECHNICAL FIELD

The present disclosure relates to a bus bar unit fixing method for fixing a bus bar unit to a fixing-object member.

### BACKGROUND ART

An effort for a purpose of mitigating or reducing an impact of climate change has been continuing in the related art, and electrification of a drive source is rapidly progressing toward implementation of the purpose.

Then, a bus bar unit may be used as one of units for exchanging large electric power between a power storage device such as a battery and the drive source according to the electrification of the drive source.

When the large electric power is exchanged between the power storage device such as a battery and the drive source by using the bus bar unit, reduction in the number of components, reduction in the number of assembling steps, and implementation of space saving have a large influence on cost reduction. Therefore, in the bus bar unit, importance of reducing the number of components, reducing the number of assembling steps, and space saving is increasing.

For example, JP2017-143024A discloses a bus bar unit in which a strength of a metal plate is increased by providing the metal plate with a bent portion. In the bus bar unit disclosed in JP2017-143024A, a force for fixing a flat plate portion to a device can be applied to a sealing member without necessarily increasing a thickness dimension of the metal plate, and therefore it is possible to prevent deterioration of a sealing property while reducing a manufacturing cost.

However, JP2017-143024A does not disclose reduction in the number of components, reduction in the number of assembling steps, and space saving in the bus bar unit.

### SUMMARY OF INVENTION

The present disclosure provides a bus bar unit fixing method capable of reducing the number of components, reducing the number of assembling steps, and space saving while reducing stress generated in a connector unit.

An aspect of the present disclosure relates to a bus bar unit fixing method,
in which a bus bar unit includes:
   a bus bar including a first end and a second end, and extending from the first end to the second end; and
   a connector unit molded to be integrated with the bus bar by insert molding,
   in which a first bolt insertion hole through which a first bolt is inserted is formed in the first end of the bus bar, and
   a second bolt insertion hole through which a second bolt is inserted is formed in the connector unit,
the bus bar unit is fixed by:
   fixing the bus bar unit to a fixing-object member;
   connecting the first end to a connection terminal provided on an electronic component; and
   connecting a cable to the second end, and
the bus bar unit fixing method has:
   a first step of inserting the first bolt through the first bolt insertion hole, and fastening the first end of the bus bar to the connection terminal provided on the electronic component; and
   a second step of inserting the second bolt through the second bolt insertion hole, and fixing the connector unit to the fixing-object member, the second step being performed after the first step.

According to the present disclosure, it is possible to reduce the number of components, reduce the number of assembling steps, and implement space saving while reducing stress generated in a connector unit.

### BRIEF DESCRIPTION OF DRAWINGS

Exemplary embodiment(s) of the present invention will be described in detail based on the following figures, wherein:

FIG. 1 is a perspective view of a power control unit to which a bus bar unit according to an embodiment of the present disclosure is attached when viewed obliquely from above:

FIG. 2 is a perspective view of the bus bar unit according to the embodiment of the present disclosure when viewed obliquely from above;

FIG. 3 is a perspective view of the bus bar unit in FIG. 2 attached to the power control unit when viewed obliquely from below:

FIG. 4 is a view of the bus bar unit in FIG. 2 attached to the power control unit when viewed from below with a part of a connector unit omitted:

FIG. 5 is a sectional view of essential parts of the bus bar unit in FIG. 2 attached to the power control unit;

FIG. 6 is a schematic view illustrating a procedure for attaching the bus bar unit in FIG. 2 to the power control unit, and

FIG. 7 is a flowchart illustrating the procedure for attaching the bus bar unit in FIG. 2 to the power control unit.

### DESCRIPTION OF EMBODIMENTS

Hereinafter, a power control unit to which a bus bar unit according to an embodiment of the present disclosure is attached will be described with reference to the accompanying drawings. Note that the drawings are viewed in directions of reference numerals. Further, in the present specification, to simplify and clarify the description, front, rear, left, right, up, and down directions are defined according to directions of a power control unit, and in the drawings, a front side is denoted by Fr, a rear side is denoted by Rr, a left side is denoted by L, a right side is denoted by R, an upper side is denoted by U, and a lower side is denoted by D. Note that the front, rear, left, right, up and lower directions in the present specification are merely defined for convenience of the description in the present specification, and the power control unit may be provided such that front, rear, left, right, up and lower directions thereof are different from the front, rear, left, right, up and lower directions illustrated in the present specification.

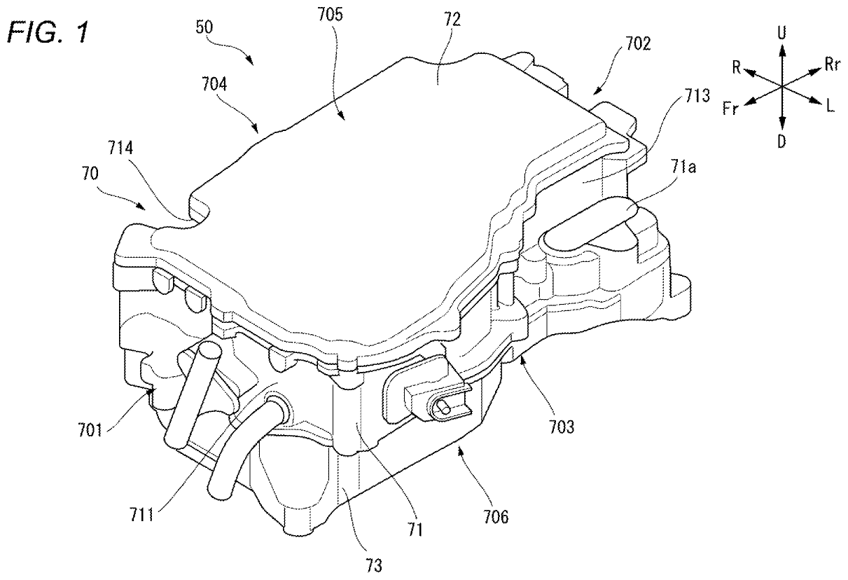

As illustrated in FIG. 1, a bus bar unit 10 according to the present embodiment is attached to a power control unit 50.

(Bus Bar Unit)

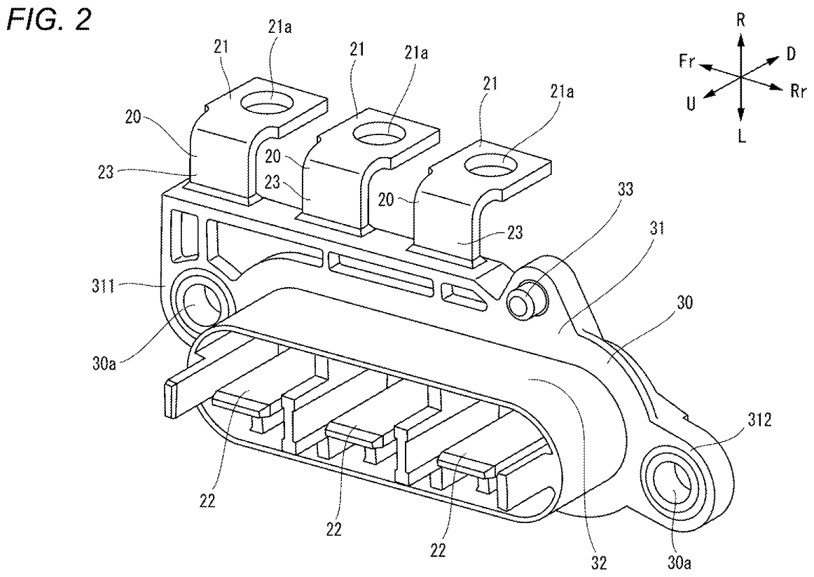

As illustrated in FIG. 2, the bus bar unit 10 includes three bus bars 20 and a connector unit 30. The three bus bars 20 are arranged side by side in a front-rear direction. The three bus bars 20 have flat plate shapes extending in parallel with one another. Each of the three bus bars 20 includes a first end 21, a second end 22, and a connection portion 23 that connects the first end 21 and the second end 22, and extends from the first end 21 to the second end 22.

The first end 21 extends in an upper-lower direction. The first end 21 has a flat plate shape substantially perpendicular to a left-right direction. A first bolt insertion hole 21a that penetrates in the left-right direction and through which a first bolt 41 is inserted is formed in the first end 21.

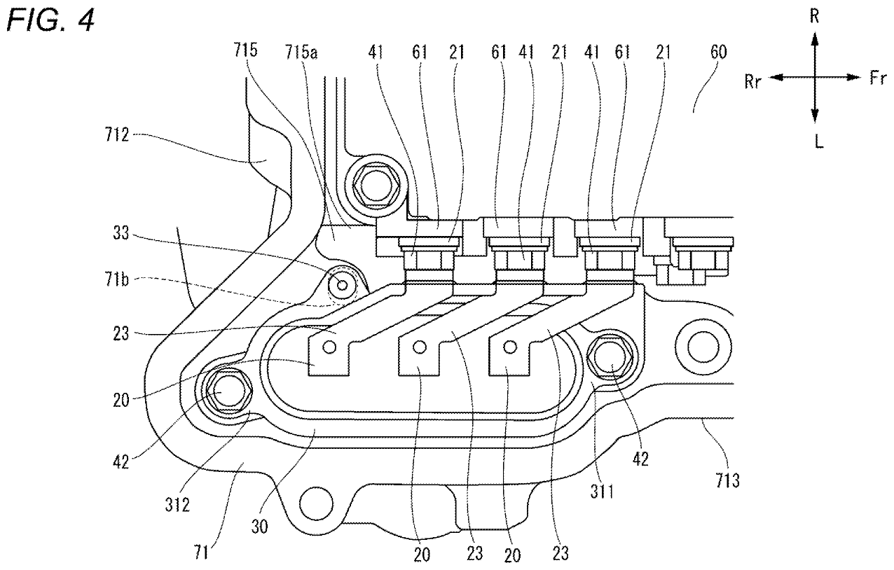

The connection portion 23 is bent from an upper end of the first end 21 and extends in a substantially horizontal direction toward an obliquely left rear side. The connection portion 23 has a flat plate shape substantially orthogonal to the upper-lower direction (see FIG. 4).

The second end 22 is bent from a left rear end of the connection portion 23 and extends upward. The second end 22 has a flat plate shape substantially perpendicular to the left-right direction.

The connector unit 30 is molded by insert molding to be integrated with the three bus bars 20. More specifically, the three bus bars 20 are inserted into a mold for injection molding, and a molten resin is injected around the three bus bars 20, thereby molding the connector unit 30, which is formed of a resin, integrated with the inserted three bus bars 20.

The connector unit 30 includes a flange portion 31 that covers at least a part of the connection portions 23 of the three bus bars 20 and extends in a substantially horizontal direction, and a side wall 32 that extends upward from an upper surface of the flange portion 31 and surrounds front, rear, left, and right of lower regions of the second ends 22 of the three bus bars 20.

The first end 21 is exposed below the flange portion 31. An upper region of the second end 22 is exposed above the side wall 32.

The connector unit 30 includes a front fastening portion 311 extending forward from a front end of the flange portion 31 and a rear fastening portion 312 extending forward from a rear end of the flange portion 31. Each of the front fastening portion 311 and the rear fastening portion 312 has a second bolt insertion hole 30a that penetrates in the upper-lower direction and through which a second bolt 42 is inserted. The second bolt insertion hole 30a is a circular hole having a diameter larger than a diameter of a shaft portion of the second bolt 42, and has a predetermined play with respect to the second bolt 42.

The connector unit 30 is provided with a positioning pin 33 extending downward from a lower surface of the flange portion 31.

(Power Control Unit)

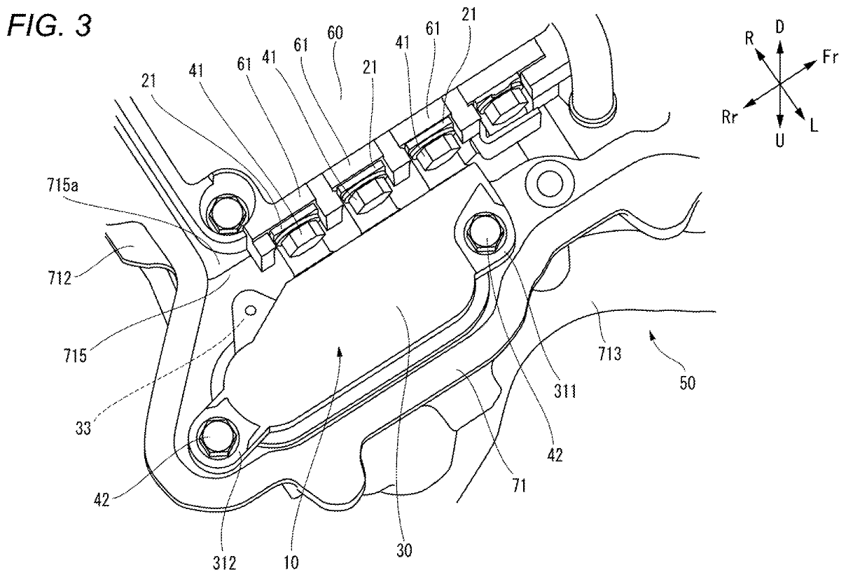

As illustrated in FIG. 1 and FIGS. 3 to 5, the power control unit 50 includes an intelligent power module (IPM) 60 and a housing case 70 that houses the intelligent power module 60.

The intelligent power module 60 is an electronic component, which controls power, including a power semiconductor element incorporating a drive circuit of a power device such as a power metal-oxide-semiconductor field-effect transistor (MOSFET) or an insulated gate bipolar transistor (IGBT).

Three connection terminals 61 are arranged side by side in the front-rear direction in the vicinity of a rear end of a left side surface of the intelligent power module 60.

The housing case 70 includes a front wall 701, a rear wall 702, a left wall 703, a right wall 704, an upper wall 705, and a lower wall 706.

The housing case 70 includes an intermediate member 71 that forms at least a part of each of the front wall 701, the rear wall 702, the left wall 703, and the right wall 704 of the housing case 70; an upper member 72 that is disposed above the intermediate member 71 and covers an upper side of the intelligent power module 60; and a lower member 73 that is disposed below the intermediate member 71 and covers a lower side of the intelligent power module 60. The upper member 72 is fixed to an upper end of the intermediate member 71 by a bolt or the like. The lower member 73 is fixed to a lower end of the intermediate member 71 by a bolt or the like.

The upper wall 705 of the housing case 70 is formed by the upper member 72. The lower wall 706 of the housing case 70 is formed by the lower member 73. In each of the front wall 701, the rear wall 702, the left wall 703, and the right wall 704 of the housing case 70, an upper region thereof is formed by the upper member 72, a lower region thereof is formed by the lower member 73, and an intermediate region in the upper-lower direction between the upper region and the lower region is formed by the intermediate member 71.

The intermediate member 71 includes a front wall 711, a rear wall 712, a left wall 713, a right wall 714, and a bottom wall 715.

The intelligent power module 60 is fixed to a lower surface 715a of the bottom wall 715 of the intermediate member 71 from below by a bolt or the like.

The bottom wall 715 of the intermediate member 71 is provided with a positioning hole 71b into which the positioning pin 33 formed in the connector unit 30 of the bus bar unit 10 can be inserted. The positioning hole 71b is a recess recessed upward from the lower surface 715a of the bottom wall 715 of the intermediate member 71. The positioning hole 71b has a long hole shape in which a dimension in the left-right direction is larger than a dimension in the front-rear direction. Further, the positioning pin 33 formed in the connector unit 30 of the bus bar unit 10 is substantially immovable in the front-rear direction and is movable by a predetermined distance in the left-right direction in a state of being inserted into the positioning hole 71b of the intermediate member 71.

Bolt fastening holes (not illustrated) into which the second bolts 42 can be screwed are formed in the bottom wall 715 of the intermediate member 71 at positions overlapping the second bolt insertion holes 30a formed in the front fastening portion 311 and the rear fastening portion 312 of the connector unit 30 when viewed in the upper-lower direction.

The intermediate member 71 is formed with a three-phase cable coupling portion 71a that penetrates the bottom wall 715 in the upper-lower direction and to which a three-phase cable 80 to be described later is coupled.

(Three-Phase Cable)

The three-phase cable 80 includes three electric wires 81, a connector 82 that holds one end of each of the three electric wires 81, and a connector shell 83 that houses and holds the connector 82.

An insertion-type terminal 81a is provided at one end of each of the three electric wires 81. The insertion-type terminals 81a provided on the three electric wires 81 are formed to be externally fittable by being inserted into the second ends 22 of the three bus bars 20 of the bus bar unit 10, respectively. When the insertion-type terminals 81a provided on the three electric wires 81 are externally fitted to the second ends 22 of the three bus bars 20 of the bus bar unit 10, the three-phase cable 80 and the three bus bars 20 of the bus bar unit 10 are electrically connected.

A sealing member 84 is provided in an outer peripheral surface of the connector 82. An annular sealing groove 82a that surrounds front, rear, left, and right is formed in the outer peripheral surface of the connector 82. The sealing member 84 is an annular elastic member such as an O-ring and is disposed in the sealing groove 82a of the connector 82.

(Bus Bar Unit Fixing Method)

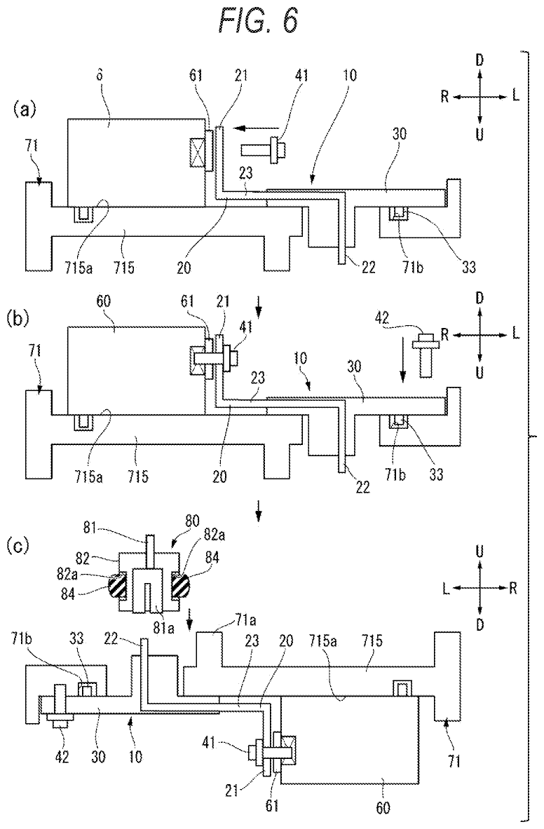

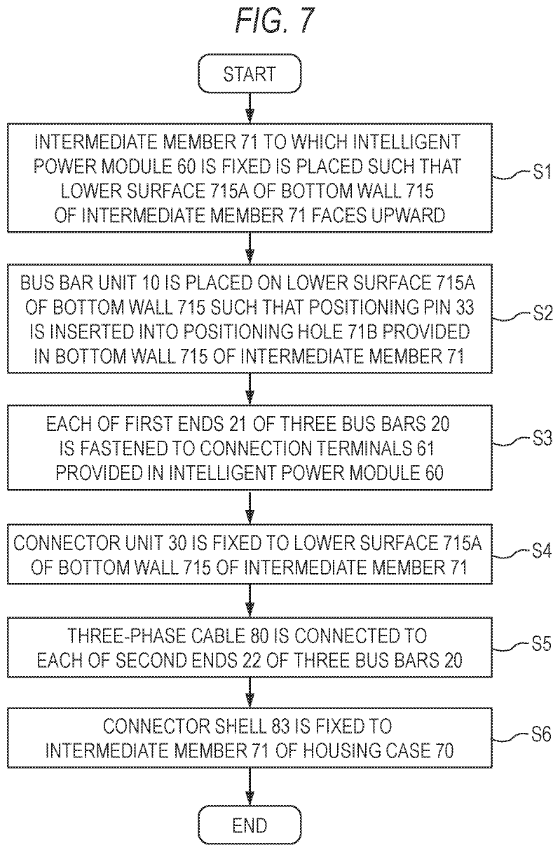

Subsequently, a bus bar unit fixing method for fixing the bus bar unit 10 to the housing case 70 will be described with reference to FIGS. 6 and 7.

As illustrated in (a) of FIG. 6, first, in a state in which the intelligent power module 60 is fixed to the lower surface 715a of the bottom wall 715 of the intermediate member 71 constituting the housing case 70 of the power control unit 50, the intermediate member 71 to which the intelligent power module 60 is fixed is placed such that the lower surface 715a of the bottom wall 715 of the intermediate member 71 faces upward (step S1).

Subsequently, the bus bar unit 10 is placed on the lower surface 715a of the bottom wall 715 such that the positioning pin 33 formed in the connector unit 30 of the bus bar unit 10 is inserted into the positioning hole 71b provided in the bottom wall 715 of the intermediate member 71 constituting the housing case 70 of the power control unit 50 (step S2).

Subsequently, the first bolts 41 are inserted from the left into the first bolt insertion holes 21a of the three bus bars 20, and the first bolts 41 are screwed into the three connection terminals 61 provided in the intelligent power module 60, respectively. Accordingly, each of the first ends 21 of the three bus bars 20 is fastened to the connection terminals 61 provided in the intelligent power module 60 (step S3).

At this time, the bus bar unit 10 is placed on the lower surface 715a of the bottom wall 715 such that the positioning pin 33 of the bus bar unit 10 is inserted into the positioning hole 71b provided in the bottom wall 715 of the intermediate member 71. As described above, the positioning pin 33 of the bus bar unit 10 is substantially immovable in the front-rear direction and is movable by a predetermined distance in the left-right direction in a state of being inserted into the positioning hole 71b of the intermediate member 71. Therefore, in step S3, when the first ends 21 of the three bus bars 20 are fastened to the connection terminals 61 provided in the intelligent power module 60, the connector unit 30 molded to be integrated with the three bus bars 20 by the insert molding is movable in the left-right direction, which is a fastening direction of the first bolt 41, together with the three bus bars 20.

After step S3, as illustrated in (b) of FIG. 6, the second bolts 42 are inserted into the second bolt insertion holes 30a formed in the front fastening portion 311 and the rear fastening portion 312 of the connector unit 30, respectively, and the second bolts 42 are screwed into the bolt fastening holes (not illustrated) formed in the bottom wall 715 of the intermediate member 71. Accordingly, the connector unit 30 is fixed to the lower surface 715a of the bottom wall 715 of the intermediate member 71 constituting the housing case 70 of the power control unit 50 (step S4).

At this time, as described above, each of the second bolt insertion holes 30a formed in the front fastening portion 311 and the rear fastening portion 312 of the connector unit 30 is a circular hole having a diameter larger than the diameter of the shaft portion of the second bolt 42, and has a predetermined play with respect to the second bolt 42. Accordingly, the connector unit 30 can be fixed to the lower surface 715a of the bottom wall 715 of the intermediate member 71 constituting the housing case 70 of the power control unit 50 by reducing stress generated in the connector unit 30 and absorbing variations in a dimension in the left-right direction generated at a time of manufacturing the connector unit 30 or the bus bar 20.

In this way, the connector unit 30 can be fixed to the lower surface 715a of the bottom wall 715 of the intermediate member 71 constituting the housing case 70 of the power control unit 50. It is possible to reduce stress generated in the connector unit 30 and absorb variations in a dimension in the left-right direction generated at a time of manufacturing the connector unit 30 or the bus bar 20, in the state in which the first ends 21 of the three bus bars 20 are fastened to the connection terminals 61 provided in the intelligent power module 60 and the connector unit 30 is fixed to the lower surface 715a of the bottom wall 715 of the intermediate member 71 constituting the housing case 70 of the power control unit 50.

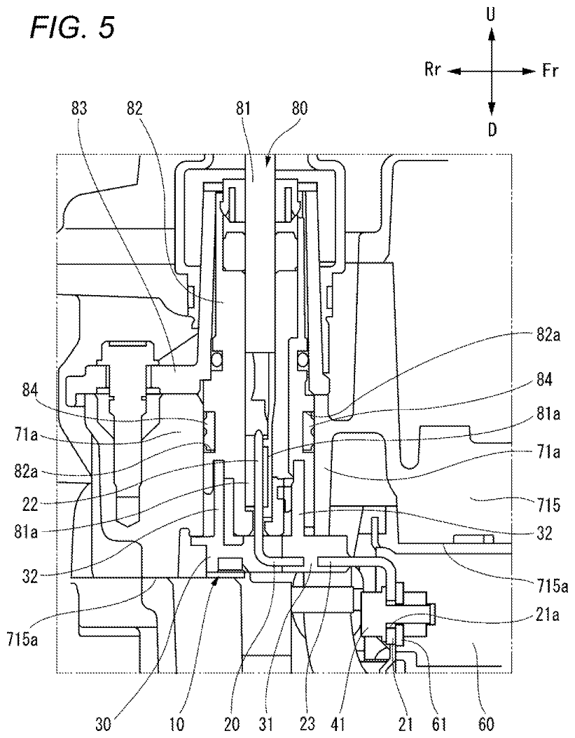

After step S4, the three-phase cable 80 is connected to each of the second ends 22 of the three bus bars 20 (step S5). In step S5, as illustrated in (c) of FIG. 6, the intermediate member 71 to which the connector unit 30 of the bus bar unit 10 and the intelligent power module 60 are fixed is turned upside down, and is placed such that the lower surface 715a of the bottom wall 715 of the intermediate member 71 faces downward. Then, the connector 82 of the three-phase cable 80 is fitted into the three-phase cable coupling portion 71a from the upper side to the lower side such that the sealing member 84 provided in the connector 82 of the three-phase cable 80 comes into close contact with an inner peripheral surface of the three-phase cable coupling portion 71a formed in the intermediate member 71 of the housing case 70. Then, while the connector 82 of the three-phase cable 80 is fitted to the three-phase cable coupling portion 71a, the insertion-type terminals 81a formed at one ends of the three electric wires 81 constituting the three-phase cable 80 are inserted from the upper side and fitted to the second ends 22 of the three bus bars 20. Accordingly, the insertion-type terminals 81a formed at one end of the three electric wires 81 constituting the three-phase cable 80 are connected to the second ends 22 of the three bus bars 20 (see FIG. 5).

In this way, according to the bus bar unit fixing method of the present embodiment, when the connection terminals 61 of the intelligent power module 60 and the three-phase cable 80 are electrically connected, there is no need to separately provide a bus bar connected to the connection terminals 61 of the intelligent power module 60 and a bus bar connected to the three-phase cable 80, and the connection terminals 61 of the intelligent power module 60 and the three-phase cable 80 can be electrically connected by one bus bar 20. Accordingly, the number of components when the connection terminals 61 of the intelligent power module 60 and the three-phase cable 80 are electrically connected can be reduced. In addition, since a step of connecting the bus bar connected to the connection terminals 61 of the intelligent power module 60 and the bus bar connected to the three-phase cable 80 can be omitted, the number of assembling steps can be reduced. Further, since there is no need to ensure a tool line for connecting the bus bar connected to the connection terminals 61 of the intelligent power module 60 and the bus bar connected to the three-phase cable 80, it is possible to improve a degree of freedom in designing the bus bar and implement space saving.

In this way, according to the bus bar unit fixing method of the present embodiment, it is possible to reduce the number of components, reduce the number of assembling steps, and implement the space saving while reducing the stress generated in the connector unit 30.

Further, the connector 82 of the three-phase cable 80 is fitted to the three-phase cable coupling portion 71a such that the sealing member 84 provided in the connector 82 of the three-phase cable 80 comes into close contact with the inner peripheral surface of the three-phase cable coupling portion 71a formed in the intermediate member 71 of the housing case 70. Therefore, water or the like can enter a space in which the insertion-type terminal 81a formed at one end of each of the three electric wires 81 constituting the three-phase cable 80 is connected to the second end 22 of the bus bar 20. In addition, since the sealing member 84 is provided in the connector 82 of the three-phase cable 80, the sealing member 84 is compressed when the connector 82 of the three-phase cable 80 is fitted into the three-phase cable coupling portion 71a. Accordingly, it is possible to absorb the variations in the dimension generated at the time of manufacturing the connector unit 30 or the bus bar 20. Accordingly, the three-phase cable 80 can absorb the variations in the dimension generated at the time of manufacturing the connector unit 30 or the bus bar 20, thereby reducing the stress generated in the connector unit 30.

After step S5, the connector shell 83 is fixed to the intermediate member 71 of the housing case 70 by a bolt or the like (step S6). Accordingly, a series of steps of fixing the bus bar unit 10 to the intermediate member 71 of the housing case 70, connection of the three-phase cable 80 to the bus bar unit 10, and fixing the three-phase cable 80 to the intermediate member 71 of the housing case 70 are completed.

Although an embodiment of the present disclosure has been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, respective constituent elements in the above embodiments may be freely combined without departing from the gist of the invention.

In the present specification, at least the following matters are described. In the parentheses, the corresponding constituent elements and the like in the above embodiment are shown as an example, but the present invention is not limited thereto.

(1) A bus bar unit fixing method,
in which a bus bar unit (bus bar unit 10) includes:
   a bus bar (bus bar 20) including a first end (first end 21) and a second end (second end 22), and extending from the first end to the second end; and
   a connector unit (connector unit 30) molded to be integrated with the bus bar by insert molding,
   in which a first bolt insertion hole (first bolt insertion hole 21a) through which a first bolt (first bolt 41) is inserted is formed in the first end of the bus bar, and
   a second bolt insertion hole (second bolt insertion hole 30a) through which a second bolt (second bolt 42) is inserted is formed in the connector unit,
the bus bar unit is fixed by:
   fixing the bus bar unit to a fixing-object member (intermediate member 71 of housing case 70);
   connecting the first end to a connection terminal (connection terminal 61) provided on an electronic component (intelligent power module 60); and
   connecting a cable (three-phase cable 80) to the second end, and
the bus bar unit fixing method includes:
   a first step (step S3) of inserting the first bolt through the first bolt insertion hole, and fastening the first end of the bus bar to the connection terminal provided on the electronic component; and
   a second step (step S4) of inserting the second bolt through the second bolt insertion hole, and fixing the connector unit to the fixing-object member after the first step.

According to (1), when the bus bar unit is fixed to the fixing-object member, it is possible to reduce the number of components, reduce the number of assembling steps, and implement space saving while reducing the stress generated in the connector unit.

(2) The bus bar unit fixing method according to (1), further including:
a third step (step S5) of connecting the cable to the second end, the cable including an electric wire (electric wire 81), an insertion-type terminal (insertion-type terminal 81a) provided at one end of the electric wire, and a connector (connector 82) configured to house the insertion-type terminal and hold the one end of the electric wire, the third step being performed after the second step,
in which the connector of the cable is provided with a sealing member (sealing member 84), and
in the third step, the connector is fitted to the fixing-object member such that the sealing member of the connector comes into close contact with the fixing-object member, and the cable is connected to the second end by inserting the insertion-type terminal of the cable.

According to (2), the sealing member of the cable can absorb the variations in the dimension generated at the time of manufacturing the connector unit or the bus bar, thereby reducing the stress generated in the connector unit.

What is claimed is:

1. A bus bar unit fixing method,
wherein a bus bar unit includes:
a bus bar including a first end and a second end, and extending from the first end to the second end; and
a connector unit molded to be integrated with the bus bar by insert molding,
wherein a first bolt insertion hole through which a first bolt is inserted is formed in the first end of the bus bar, and
a second bolt insertion hole through which a second bolt is inserted is formed in the connector unit,
the bus bar unit is fixed by:
fixing the bus bar unit to a fixing-object member;
connecting the first end to a connection terminal provided on an electronic component; and
connecting a cable to the second end, and
the bus bar unit fixing method comprises:
a first step of inserting the first bolt through the first bolt insertion hole, and fastening the first end of the bus bar to the connection terminal provided on the electronic component; and
a second step of inserting the second bolt through the second bolt insertion hole, and fixing the connector unit to the fixing-object member, the second step being performed after the first step.

2. The bus bar unit fixing method according to claim 1, further comprising:
a third step of connecting the cable to the second end, the cable including an electric wire, an insertion-type terminal provided at one end of the electric wire, and a connector configured to house the insertion-type terminal and hold the one end of the electric wire, the third step being performed after the second step,
wherein the connector of the cable is provided with a sealing member, and
in the third step, the connector is fitted to the fixing-object member such that the sealing member of the connector comes into close contact with the fixing-object member, and the cable is connected to the second end by inserting the insertion-type terminal of the cable.
